(19) United States
(12) Patent Application Publication
(10) Pub. No.: US 2010/0013588 A1
(43) Pub. Date: Jan. 21, 2010

(54) COIL DEVICE WITH BOBBIN STRUCTURE

(75) Inventor: Sadakatsu SAKUMA, Sendai-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: NEC TOKIN Corporation, Sendai-shi (JP)

(21) Appl. No.: 12/501,583

(22) Filed: Jul. 13, 2009

(30) Foreign Application Priority Data
Jul. 17, 2008 (JP) 2008-185452

(51) Int. Cl. H01F 27/32

(52) U.S. Cl. 336/198

(57) ABSTRACT

A coil device comprises a bobbin structure, three or more pin lines and two or more coils. The bobbin structure comprises a body section, a first flange section and a second flange section. The body section is positioned between the first flange section and the second flange section in a first horizontal direction. The first flange section comprises a first lower base and a first upper portion. The first upper portion extends upwardly from the first lower base. The first upper portion is provided with a first upper edge on which at least one guide recess is formed. The second flange section comprises a second lower base and a second upper portion. The second lower base faces the first lower base in the first horizontal direction. The second upper portion extends upwardly from the second lower base. The second upper portion faces the first upper portion in the first horizontal direction with the body section interposed therebetween. Each of the pin lines consists of two or more pins arranged in a second horizontal perpendicular to the first horizontal direction. Two or more of the pin lines extend downwardly from the first lower base. One or more of the pin lines extends downwardly from the second lower base. Each of coils comprises a wrapped portion and two twisted portions extending from the wrapped portion. The wrapped portions of the coils are wrapped around the body section of the bobbin structure so that the coils have their axes extending along the first horizontal direction. Each of the twisted portions is twisted around one of the pins. At least one of the twisted portions is guided by the at least one guide recess and extends over the first upper edge to a corresponding one of the pins.

### CROSS REFERENCE TO RELATED APPLICATIONS

An applicant claims priority under 35 U.S.C. §119 of Japanese Patent Application No. JP2008-185452 filed Jul. 17, 2008.

### BACKGROUND OF THE INVENTION

This invention relates to a coil device such as a transformer or a choke coil used in an inverter circuit or the like and, in particular, to a low-profile coil device which includes a bobbin structure and coils wrapped around the bobbin structure.

Coil devices are generally grouped into two types: vertical type and horizontal type. A coil device of the vertical type has coils which are arranged so that their coil axes extend vertically. Another coil device of the horizontal type has coils which are arranged so that their coil axes extend horizontally. Recently, coil devices are required to have a low-profile with more coils. In view of the requirement, the horizontal-type coil device has advantages in its characteristics in comparison with the vertical-type coil device. For example, one of the horizontal-type coil devices is disclosed in JP-A 2005-72261, the contents of which are incorporated herein by reference.

As disclosed in JP-A 2005-72261, a normal coil device of the horizontal type has two pin lines, each of which consists of multiple pins or terminals. If the number of coils increases, each of the pin lines must be longer. The longer pin lines lose the size balance of the coil device.

In order to solve the above-mentioned size balance problem, JP-A 2004-260089 proposes a coil device of horizontal type that has four pin lines, the contents of JP-A 2004-260089 being incorporated herein by reference. However, the coil device of JP-A 2004-260089 has a complex structured coil bobbin formed with a plurality of holes which pierces its flange portions along a direction parallel with its coil axes. Because of the piercing holes, the complex structured coil bobbin is difficult to mold and does not have its adequate strength. JP-A 2000-150258 and JP-A 2008-147265 disclose other coil devices each of which comprises three or more pin lines but is of the vertical type. Therefore, the coil device of JP-A 2000-150258 or JP-A 2008-147265 is difficult to have a low-profile with multiple coils, as mentioned above.

### SUMMARY OF THE INVENTION

It is an object of the present invention to provide a coil device which can have a low-profile with adequate strength even if it has and a small size but has many pins

One aspect of the present invention provides a coil device which comprises a bobbin structure, three or more pin lines and two or more coils. The bobbin structure comprises a body section, a first flange section and a second flange section. The body section is positioned between the first flange section and the second flange section in a first horizontal direction. The first flange section comprises a first lower base and a first upper portion. The first upper portion extends upwardly from the first lower base. The first upper portion is provided with a first upper edge on which at least one guide recess is formed. The second flange section comprises a second lower base and a second upper portion. The second lower base faces the first lower base in the first horizontal direction. The second upper portion extends upwardly from the second lower base. The second upper portion faces the first upper portion in the first horizontal direction with the body section interposed therebetween. Each of the pin lines consists of two or more pins arranged in a second horizontal perpendicular to the first horizontal direction. Two or more of the pin lines extend downwardly from the first lower base. One or more of the pin lines extends downwardly from the second lower base. Each of coils comprises a wrapped portion and two twisted portions extending from the wrapped portion. The wrapped portions of the coils are wrapped around the body section of the bobbin structure so that the coils have their axes extending along the first horizontal direction. Each of the twisted portions is twisted around one of the pins. At least one of the twisted portions is guided by the at least one guide recess and extends over the first upper edge to a corresponding one of the pins.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1A is a top plan view schematically showing a coil device according to an embodiment of the present invention, wherein the coil device includes a bobbin structure.

FIG. 1B is a side view schematically showing the coil device of FIG. 1A.

FIG. 1C is a front view schematically showing the coil device of FIG. 1A.

FIG. 1D is a bottom plan view schematically showing the coil device of FIG. 1A.

FIG. 1E is a circuit diagram schematically showing of equivalent circuits of the coil device of FIG. 1A.

FIG. 2A is a top plan view schematically showing the bobbin structure of FIG. 1A, wherein the bobbin structure comprises a main member and a cover member.

FIG. 2B is a side view schematically showing the bobbin structure of FIG. 2A.

FIG. 2C is a front view schematically showing the bobbin structure of FIG. 2A.

FIG. 2D is a bottom plan view schematically showing the bobbin structure of FIG. 2A.

FIG. 3A is a top plan view schematically showing the cover member of FIG. 2A.

FIG. 3B is a side view schematically showing the cover member of FIG. 3A.

FIG. 3C is a front view schematically showing the cover member of FIG. 3A.

FIG. 3D is an exploded, side view schematically showing the bobbin structure of FIG. 2A.

FIG. 4A is a top plan view schematically showing a coil device according to another embodiment of the present invention, wherein the coil device includes a bobbin structure.

FIG. 4B is a side view schematically showing the coil device of FIG. 4A.

FIG. 4C is a front view schematically showing the coil device of FIG. 4A.

FIG. 4D is a bottom plan view schematically showing the coil device of FIG. 4A.

FIG. 4E is a circuit diagram schematically showing of equivalent circuits of the coil device of FIG. 4A.

FIG. 5A is a top plan view schematically showing the bobbin structure of FIG. 4A, wherein the bobbin structure comprises a main member and a cover member.

FIG. 5B is a side view schematically showing the bobbin structure of FIG. 5A.

FIG. 5C is a front view schematically showing the bobbin structure of FIG. 5A.

FIG. 5D is a bottom plan view schematically showing the bobbin structure of FIG. 5A.

FIG. 6A is a top plan view schematically showing the cover member of FIG. 5A.

FIG. 6B is a side view schematically showing the cover member of FIG. 6A.

FIG. 6C is a front view schematically showing the cover member of FIG. 6A.

FIG. 6D is an exploded, side view schematically showing the bobbin structure of FIG. 5A.

FIG. 7A is a bottom plan view schematically showing a coil device according to a first comparative example.

FIG. 7B is a bottom plan view schematically showing a coil device according to a second comparative example.

FIG. 8 is a bottom plan view schematically showing a coil device according to a third comparative example.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DESCRIPTION OF PREFERRED EMBODIMENTS

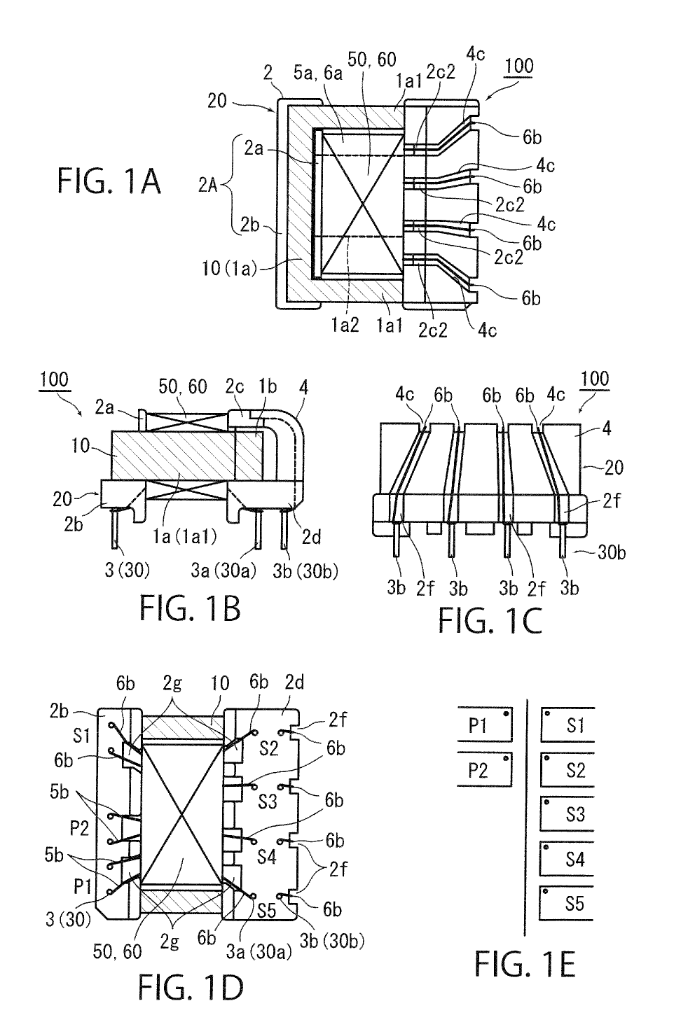

With reference to FIGS. 1A to 1D, a coil device 100 according to a first embodiment of the present invention comprises a magnetic core 10, a bobbin structure 20, three pin lines 30, 30a, 30b, a plurality of primary coils 50 and a plurality of secondary coils 60. As shown in FIGS. 1D and 1E, the number of the primary coils 50 (primary circuits P1, P2) is two, while the number of the secondary coils 60 (secondary circuits S1 to S5) is five in the present embodiment.

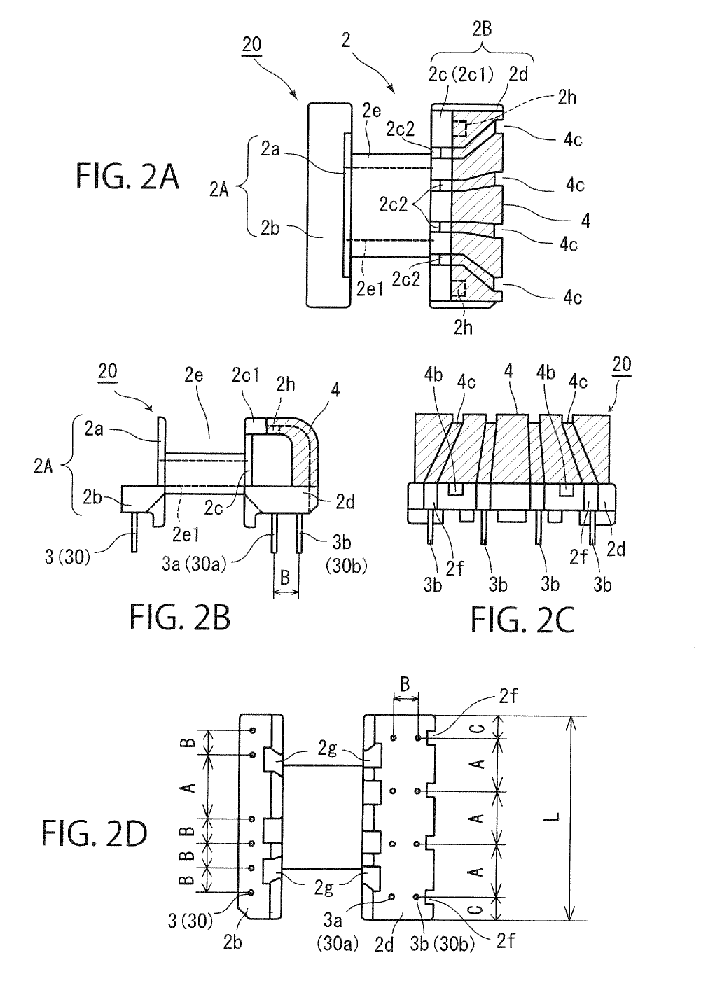

With reference to FIGS. 1A, 1B and 1D, the magnetic core 10 of the present embodiment is of an EI type and comprises an E-shaped core 1a and an I-shaped core 1b. The E-shaped core 1a includes two side legs 1a1 and a center leg 1a2. The side legs 1a1 and the center leg 1a2 are parallel with each other. Each of the side legs 1a1 and the center leg 1a2 extends in a first horizontal direction, which is a lateral direction in FIGS. 1A, 1B and 1D. The center leg 1a2 serves as an inserted portion which is inserted into and is held by the bobbin structure 20, as explained in later. The I-shaped core 1b extends in a second horizontal direction which is perpendicular to the first horizontal direction and is another lateral direction in FIG. 1C. The I-shaped core 1b serves as an outer portion which is held by the bobbin structure 20, as explained in later. As apparent from FIGS. 1B and 2B, the center leg 1a2 is thinner than the remaining parts of the magnetic core 10, especially, the I-shaped core 1b and the side legs 1a1 so that the coil device 100 of the present embodiment has a lower-profile. However, the present invention is not limited thereto. The center leg 1a2 may be thicker than the illustrated one. For example, the center leg 1a2 may have a thickness equal or substantially equal to the I-shaped core 1b and/or the side legs 1a1. It is preferable that the magnetic core 10 is made of Mn—Zn based ferrite or Ni—Zn based ferrite, in consideration of high permeability, low loss, and suitability to high frequency. In addition, the magnetic core 10 may be made of magnetic amorphous. Also, a dust core may be used as the magnetic core 10. It is preferable that the material of the magnetic core 10 is selected in consideration of the application of the magnetic core 10.

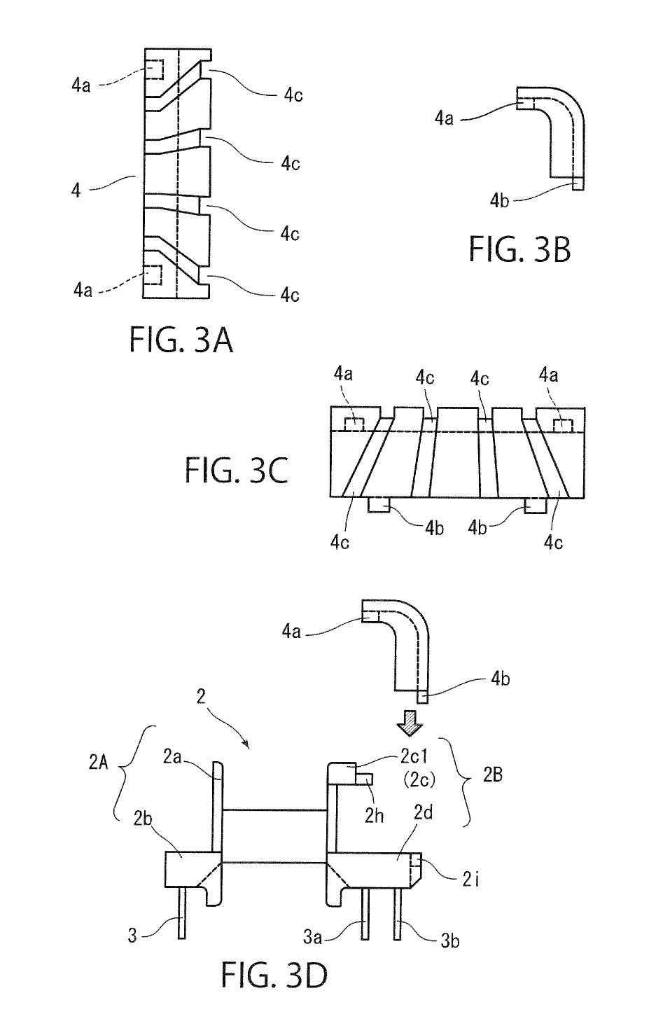

With reference to FIGS. 2A to 2D and FIG. 3D, the bobbin structure 20 of the present embodiment comprises a bobbin main 2 and a cover member (cover section) 4. In this embodiment, the bobbin main 2 and the cover member 4 are distinct members, and the bobbin structure 20 is a combination thereof. However, the present invention is not limited thereto. The bobbin main 2 and the cover section 4 may be formed integrally with each other. In other words, the bobbin structure 10 may be formed as a single member.

The illustrated bobbin main 2 comprises a body section 2e, a first flange section 2B and a second flange section 2A. As best shown in FIG. 2A, the bobbin main 2 is formed with a hollow 2e1 which extends in the first horizontal direction and into which the center leg 1a2 is inserted as the inserted portion, as apparent from FIGS. 1A and 2A.

Turning back to FIGS. 2A to 2D and FIG. 3D, the body section 2e is positioned between the first flange section 2B and the second flange section 2A in the first horizontal direction. The first flange section 2B comprises a first lower base 2d and a first upper portion 2c, which extends upwardly from the first lower base 2d. The second flange section 2A comprises a second lower base 2b and a second upper portion 2a, which extends upwardly from the second lower base 2b. The second lower base 2b faces the first lower base 2d in the first horizontal direction. Likewise, the second upper portion 2a faces the first upper portion 2c in the first horizontal direction with the body section 2e interposed between the first upper portion 2c and the second upper portion 2a.

In this embodiment, the second upper portion 2a has a simple plate-like shape, while the first upper portion 2c has a plate-like shape with a first upper edge 2c1 which projects outwards in the first horizontal direction. As shown in FIGS. 1A and 2A, the first upper edge 2c1 is formed with guide recesses 2c2. The number of the guide recesses 2c2 of four in the present embodiment. The guide recesses 2c2 serve to guide the coils (the secondary coils 60) in part, as illustrated in FIG. 1A; the guide of the parts of the coils are also explained afterwards. As shown in FIGS. 2A, 2B and 3D, the first upper edge 2c1 of the present embodiment is formed with two projections 2h which further project outwards in the first horizontal direction. As shown in FIG. 3D, the first lower base 2d is formed with two depressions 2i, which are positioned at one end of the first lower base 2d in the first horizontal direction and are depressed downwardly. The first lower base 2d is formed with guide grooves 2f and guide depressions 2g. The guide grooves 2f are positioned on an outer side surface of the first lower base 2d. The guide depressions 2g are positioned at an inner-lower edge of the first lower base 2d. Likewise, the second lower base 2b is also formed with guide depressions 2g which are positioned at an inner-lower edge of the second lower base 2b.

With reference to FIGS. 2B and 3B, the cover member 4 has a general L-like shape, as seen along the second horizontal direction. The cover member 4 connects between the first upper edge 2c and the first lower base 2d to define a space extending along the second horizontal direction. As shown in FIG. 1B, the I-shaped core 1b, i.e. the outer portion of the magnetic core 10 is disposed on the first lower base 2d and is accommodated in the defined space. In other words, the cover member 4 covers the outer portion of the magnetic core 10, i.e. the I-shaped core 1b.

With reference to FIGS. 3B and 3C, the cover member 4 is formed with two depressions 4a and two projections 4b. As apparent from FIG. 3D, the depressions 4a receive the projections 2h, respectively, while the projections 4b are received by the depressions 2i, respectively. With reference to FIGS. 1C, 2A, 2C, 3A and 3C, a plurality of guide grooves 4c are formed in an outer surface of the cover member 4. The guide grooves 4c correspond to the guide recesses 2c2, respectively. The number of the guide grooves 4c is four in the present embodiment. The guide grooves 4c serve to guide the coils (the secondary coils 60) in part, as illustrated in FIGS. 1A and 1C; the guide of the parts of the coils are also explained afterwards.

The bobbin structure 20 may be made of thermosetting resin or thermoplastic resin. Examples of the thermosetting resin are epoxy resin, phenol resin and so on. Examples of the thermoplastic resin are polypropylene, polystyrene, polybutylene terephthalate, nylon and so on. The bobbin main 2 may be made of different material than the cover member 4. The body section 2e may have any shape. It is preferable that the body section 2e has a rectangular cross-section in consideration of low profile requirement for the coil device 100. However, it is further preferable that the rectangular cross-section of the body section 2e has rounded corners in consideration of possibility of damage of the coils. For the same reason, the guide grooves 2f, 4c and the guide depressions 2g are preferably rounded.

With reference to FIGS. 1B, 1D, 2B and 2D, the pin line 30 is held by the second lower base 2b, while the pin lines 30a, 30b are held by the first lower base 2d. Specifically, the pin line 30a is an inner pin line, while the pin line 30b is an outer pin line. In other words, the pin line 30a is positioned inside the pin line 30b in the first horizontal direction. Each of the pin lines 30, 30a, 30b consists of a plurality of pins 3, 3a, 3b, which are arranged in the second horizontal direction. Specifically, the pin line 30 consists of six pins 3; the pin line 30a consists of four pins 3a; the pin line 30b consists of four pins 3b. Each of the pins 3, 3a, 3b extends downwardly from a corresponding one of the first lower base 2d and the second lower base 2b. In this embodiment, each pair of the pin 3a and the pin 3b is arranged along the first horizontal direction, as shown in FIGS. 1D and 2D. The pin arrangement makes the size of the bobbin structure 20 small. The pins 3, 3a, 3b may be made of any conductive material. It is preferable that the pins may be made of copper-plated metal wire or hard-drawn copper wire because of low cost. The pins 3, 3a, 3b may have a cross-section of any shape.

With reference to FIG. 1A, each of the primary coils 50 comprises a wrapped portion 5a and two twisted portions 5b. The wrapped portion 5a is wrapped around the body section 2e so that the primary coil 50 has its axis extending along the first horizontal direction. The twisted portions 5b extend from both ends of the wrapped portion 5a. Each of the twisted portions 5b is guided by one of the guide depressions 2g and is twisted around a corresponding one of the pins 3, as shown in FIG. 1D.

Likewise, with reference to FIG. 1A, each of the secondary coils 60 comprises a wrapped portion 6a and two twisted portions 6b. The wrapped portion 6a is wrapped around the body section 2e so that the secondary coil 60 has its axis extending along the first horizontal direction. The twisted portions 6b extend from both ends of the wrapped portion 6a. Each of the twisted portions 6b is twisted around a corresponding one of the pins 3, 3a, 3b. As shown in FIG. 1D, one pair of the twisted portions 6b is guided by one of the guide depressions 2g to be twisted around the pins 3. These twisted portions 6b twisted around the pin 3 belong to the secondary circuit S1. As shown in FIGS. 1A, 1C and 1D, ones of the twisted portions 6b belonging to the remaining pairs extend from the wrapped portion 6a over the first upper edge 2c to the pins 3b of the outer pin line 30b, respectively, and are twisted around the pins 3b. The other twisted portions 6b of the remaining pairs are guided by the guide depressions 2g and are twisted around the pins 3a of the inner pin line 30a, respectively. These twisted portions 6b twisted around the pins 3a, 3b belong to one of the secondary circuits S2 to S5. In this embodiment, the twisted portions 6b twisted around the pins 3b are guided by the respective guide recesses 2c2 of the first upper edge 2c and the respective guide grooves 4c of the cover member 4. Because of the cover member 4, the guided twisted portions 6b are positioned away from and are separated from the magnetic core 10.

Each of the primary coils 50 and the secondary coils 60 may be made of any materials such as enameled wire or polyurethane coated copper wire. Reinforced insulation wire may be used. Each of the primary coils 50 and the secondary coils 60 may have any cross-section.

The above-mentioned coil device 100 is fabricated by as follows. The wrapped portions 5a, 6a are wrapped around the body section 2e, while the cover member 4 is attached to the bobbin main 2. The twisted portions 5b, 6b are twisted around the pins 3, 3a, 3b. The I-shaped core 1b is inserted into the space defined by the cover member 4 and the first flange section 2B. The center leg 1a2 of the E-shaped core 1a is inserted into the hollow 2e1. The E-shaped core 1a is fixed to the I-shaped core 1b by for example an adhesive agent. The thus-fabricated coil device 100 has a good size balance, while the pins 3a, 3b are sufficiently separated from each other, because the pins 3a, 3b are arranged in two pin lines 30a, 30b,

Although the shape of the magnetic core 10 is of the EI-type, the shape of the magnetic core 10 may be other shapes such as an EE-type core. If the EE-type core is used, the core is attached to the bobbin main 2 before the cover member 4 is attached to the bobbin main 2. The center leg of the magnetic core 10 also may have any shape. In view of low profile requirement, it is preferable that the center leg has a rectangular cross-section. Although the bobbin structure 20 of the present embodiment has only one cover member 4, the bobbin structure 20 may have two cover members 4, which are attached to the first flange section 2B and the second flange section 2A, respectively. In the case of two cover members 4, the magnetic core 10 is attached to the bobbin main 2 before the cover members 4 are attached to the bobbin main 2.

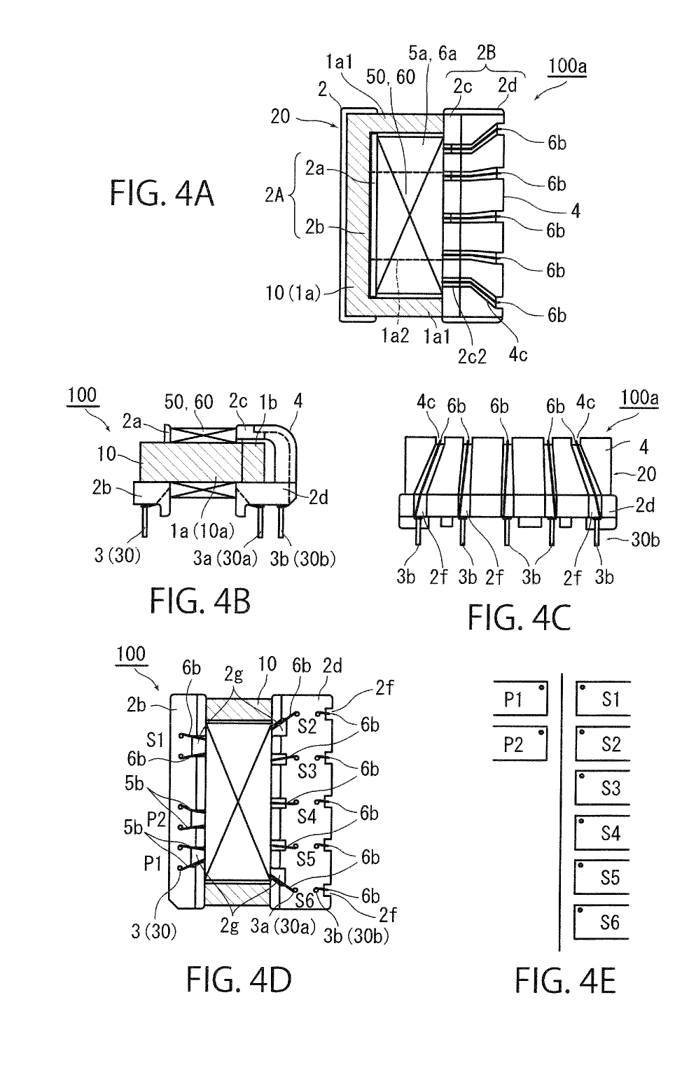

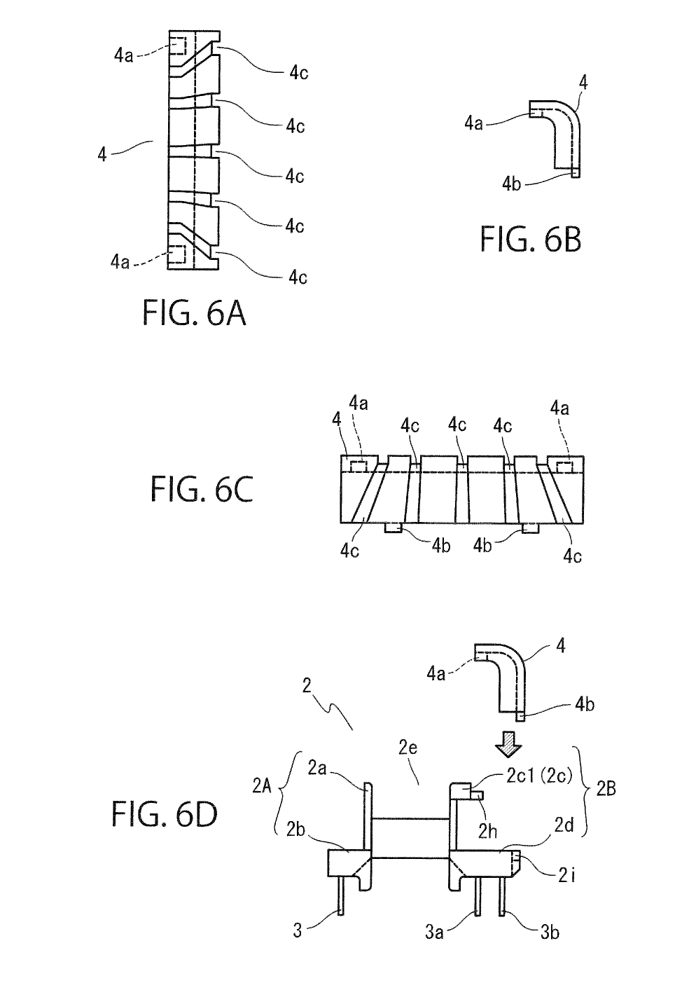

With reference to FIGS. 4A to 4E, 5A to 5D, and 6A to 6D, a coil device 100a according to a second embodiment of the present invention is a modification of the coil device 100 of the first embodiment. The coil device 100a is different from the coil device 100 in the number of circuits, i.e. the number of coils. The coil device 100a comprises two primary circuits P1, P2 and six secondary circuits S1 to S6. In this connection, the pin line 30a consists of five pins 3a, while the pin line 30b consists of five pins 3b. In addition, the first upper edge 2c1 is formed with five guide recesses 2c2, the cover member 4 is formed with five guide grooves 4c, and the first lower base 2d is formed with five guide grooves 2f. The coil device 100a has a good size balance, while the pins 3a, 3b are sufficiently separated from each other, because the pins 3a, 3b are arranged in two pin lines 30a, 30b.

Examples and comparative examples were fabricated and were evaluated.

Example 1 was the coil device 100 according to the first embodiment. In FIG. 2D, the size A was 6 mm, the size B was 2.5 mm, the size C was 2 mm. The magnetic core 10 was of the EI-type and was made of Mn—Zn based ferrite. The E-shaped core 1a had a profile of 15 mm×13 mm×4.5 mm. The center leg had a rectangular cross-section which had rounded corners of 0.5 mm curve. The I-shaped core 1b had a shape of 15 mm×2 mm×4.5 mm. The bobbin main 2 was made of phenol based thermosetting resin. Each of the guide grooves 2f and the guide depressions 2g had a width of 1 mm and a depth of 1 mm. In order to prevent damage of the coil, the guide grooves 2f and the guide depressions 2g were rounded at 0.5 mm curve. The cover member 4 was made of polystyrene thermoplastic resin and had a shape of 6 mm×20 mm×8 mm (height). Each of the guide grooves 4c had a width of 1 mm and a depth of 1 mm. In order to prevent damage of the coil, the guide grooves 4c were rounded at 0.5 mm curve. Each of the primary coils 50 was formed of twelve turns of polyurethane coated copper wire, which had a diameter of 0.3 φ. Each of the secondary coils 60 was formed of twenty turns of insulated wires, which had a diameter of 0.15 φ. The twisted portions 5b and 6b were twisted around the pins 3, 3a, 3b and were then fixed by soldering.

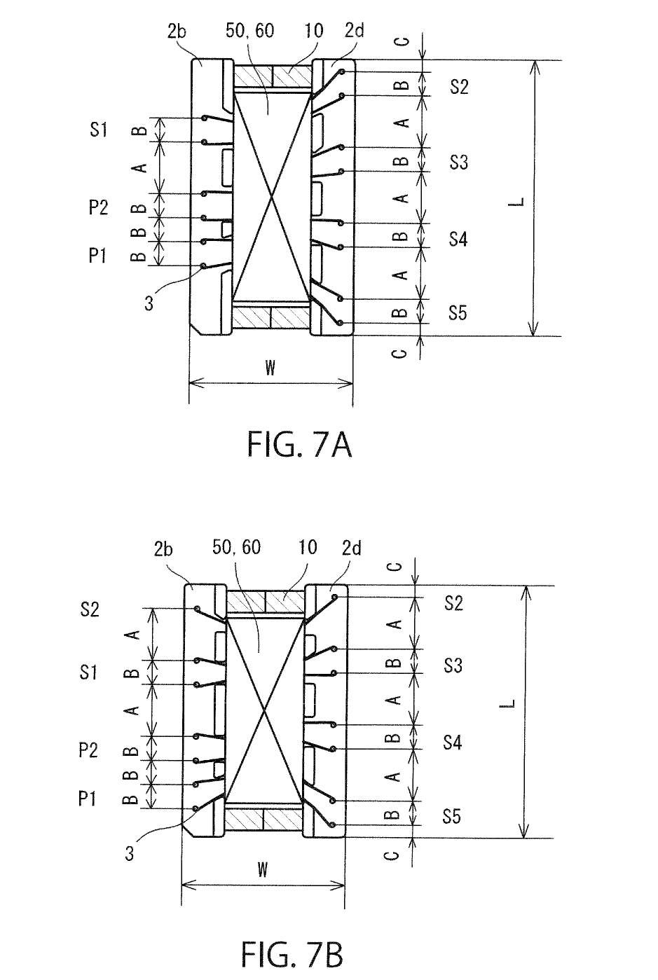

Comparative Example 1 and Comparative Example 2 were fabricated in accordance with FIGS. 7A and 7B, respectively, Comparative Example 2 had a smaller size L than Comparative Example 1 by size B because the twisted portions of the circuit S2 were twisted around the pins which were fixed to the different lower bases 2d, 2b.

The evaluation result is shown in Table 1.

TABLE 1

| | | | | Weight of |
|---|---|---|---|---|
| | | | Plane Size of | Magnetic |
| | Number of | Implementation | Magnetic Core | Core |
| | Circuits | Area (mm²) | (mm × mm) | (g) |
| Example 1 | P: 2; S: 5 | 495 | 18.4 × 24.2 | 8.2 |
| | | L 22 × W 22.5 | | |
| Comparative | P: 2; S: 5 | 640 | 18.4 × 34.0 | 11.6 |
| Example 1 | | L 32 × W 20 | | |
| Comparative | P: 2; S: 5 | 590 | 18.4 × 30.9 | 10.5 |
| Example 2 | | L 29.5 × W 20 | | |

P: Primary Circuit,
S: Secondary Circuit

As apparent from Table 1, Example 1 has an implementation area which is about 80% of that of Comparative Example 1 or Comparative Example 2. The weight of the magnetic core of Example 1 is decreased by about 22% in comparison with Comparative Example 1 or Comparative Example 2.

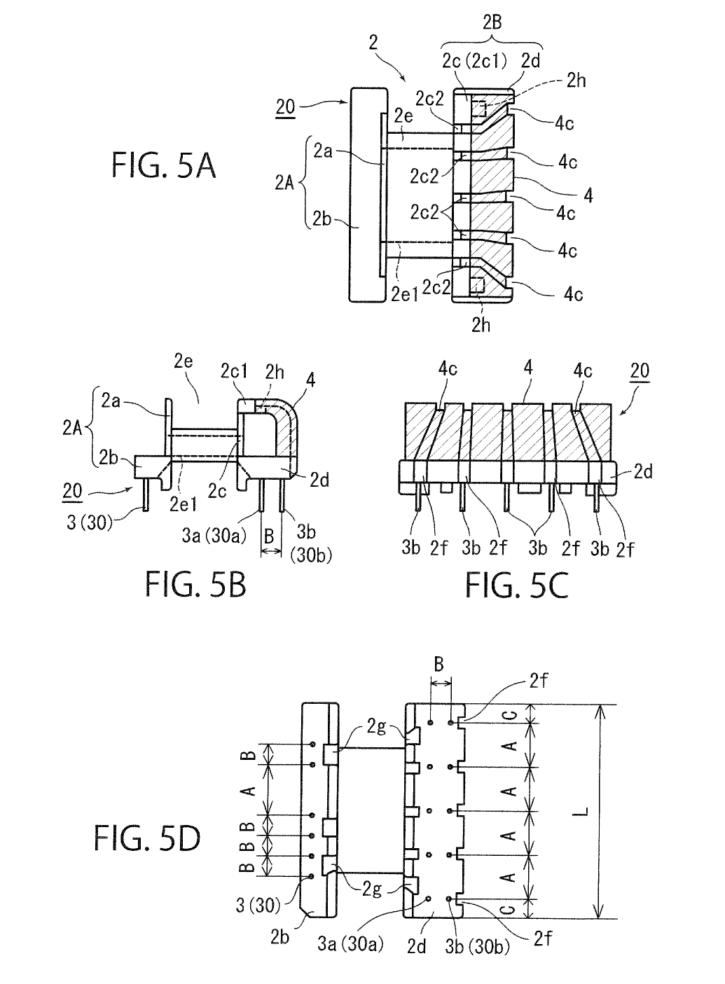

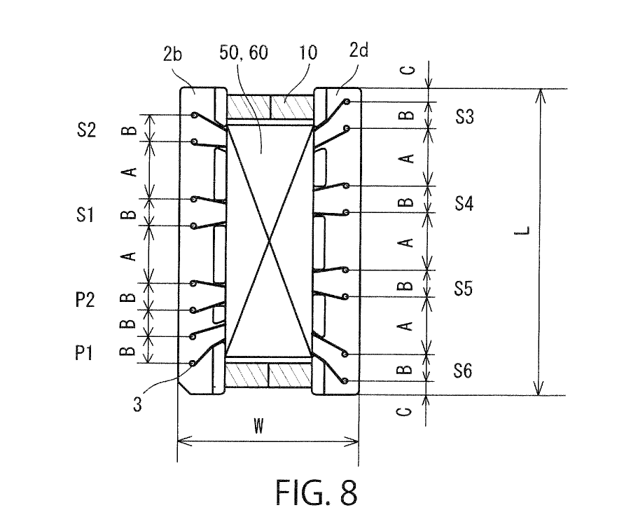

Example 2 was the coil device 100a according to the second embodiment, Example 2 was fabricated in accordance with conditions similar to Example 1, except for the number of the secondary coils 60. For example, In FIG. 5D, the size A was 6 mm, the size B was 2.5 mm, the size C was 2 mm. Comparative Example 3 was fabricated in accordance with FIG. 8.

The evaluation result is shown in Table 2.

TABLE 2

| | | | | Weight of |
|---|---|---|---|---|
| | | | Plane Size of | Magnetic |
| | Number of | Implementation | Magnetic Core | Core |
| | Circuits | Area (mm²) | (mm × mm) | (g) |
| Example 2 | P: 2; S: 6 | 630 | 18.4 × 30.9 | 10.5 |
| | | L 28 × W 22.5 | | |
| Comparative | P: 2; S: 6 | 640 | 18.4 × 34.0 | 11.6 |
| Example 3 | | L 32 × W 20 | | |

P: Primary Circuit,
S: Secondary Circuit

As apparent from Table 2, Example 2 has an implementation area smaller than that of Comparative Example 3. The weight of the magnetic core of Example 2 is decreased by about 10% in comparison with Comparative Example 3. The plane size of the magnetic core of Example 2 is smaller than that of Comparative Example 3 and is equivalent to that of Comparative Example 2 which has the small number of coils.

The present application is based on a Japanese patent application of JP2008-185452 filed before the Japan Patent Office on Jul. 17, 2008, the contents of which are incorporated herein by reference.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A coil device comprising:
a bobbin structure comprising a body section, a first flange section and a second flange section the body section being positioned between the first flange section and the second flange section in a first horizontal direction the first flange section comprising a first lower base and a first upper portion, the first upper portion extending upwardly from the first lower base, the first upper portion being provided with a first upper edge on which at least one guide recess is formed, the second flange section comprising a second lower base and a second upper portion, the second lower base facing the first lower base in the first horizontal direction, the second upper portion extending upwardly from the second lower base, the second upper portion facing the first upper portion in the first horizontal direction with the body section interposed therebetween;
three or more pin lines, each of the pin lines consisting of two or more pins arranged in a second horizontal perpendicular to the first horizontal direction, two or more of the pin lines extending downwardly from the first lower base, one or more of the pin lines extending downwardly from the second lower base; and
two or more coils, each of coils comprising a wrapped portion and two twisted portions extending from the wrapped portion, the wrapped portions of the coils being wrapped around the body section of the bobbin structure so that the coils have their axes extending along the first horizontal direction, each of the twisted portions being twisted around one of the pins, at least one of the twisted portions being guided by the at least one guide recess and extending over the first upper edge to a corresponding one of the pins.

2. The coil device according to claim 1, wherein:
the first lower base is provided with two of the pin lines which consists of an inner pin line and an outer pin line;
ones of the twisted portions are twisted around the pins belonging to the inner pin line; and
other ones of the twisted portions are twisted around the pins belonging to the outer pin line.

3. The coil device according to claim 1, further comprises a magnetic core, wherein:
the magnetic core comprises an inserted portion and an outer portion;
the bobbin structure is formed with a hollow extending therethrough along the first horizontal direction;
the inserted portion is inserted into the hollow;
the outer portion is arranged on the first lower base;
the bobbin structure comprises a cover section;
the cover section connects between the first upper edge and the first lower base to cover the outer portion of the magnetic core; and
the at least one twisted portion is arranged on an outer surface of the cover section so as to be positioned away from the magnetic core.

4. The coil device according to claim 3, wherein the cover section is provided with at least one guide groove which corresponds to the at least one guide recess and is formed on the outer surface of the cover section, the at least one guide groove guiding the at least one twisted portion from the wrapped portion through the at least one guide recess of the first upper edge to the pin around which the at least one twisted portion is twisted.

5. The coil device according to claim 3, wherein the magnetic core is of an EI type, which comprises an E-shaped core and an I-shaped core, the E-shaped core includes two side legs and a center leg positioned between the side legs, the center leg being used as the inserted portion.

6. The coil device according to claim 5, wherein the I-shaped core is used as the outer portion.
